(19) United States
(12) Patent Application Publication
(10) Pub. No.: US 2003/0217190 A1
(43) Pub. Date: Nov. 20, 2003

(54) Service description and development processes

(76) Inventors: Geoffrey Devine, Portsmouth, NH (US); Patrick Quigley, Hampstead, NH (US); Rajaesh Mishra, Westford, MA (US); Julian Wray West, Derry, NH (US); Mark Galvin, Derry, NH (US)

Correspondence Address: ROPES & GRAY LLP, ONE INTERNATIONAL PLACE, BOSTON, MA, 02110-2624, US

(21) Appl. No.: 10/430,052

(22) Filed: May 5, 2003

Related U.S. Application Data
(60) Provisional application No. 60/377,680, filed on May 3, 2002.
(60) Provisional application No. 60/430,720, filed on Dec. 3, 2002.

(51) Int. Cl. G06F 9/46

(52) U.S. Cl. 709/318

(57) ABSTRACT

The systems and methods described herein include, among other things, state machine design tools that generate computer executable state machines from schematic representations, typically flow charts, of a process. In one particular embodiment the proscesses being represented are processes for implementing a telephony or telecommunication service. For example, the methods described herein include state machine design tools that allow a user to generate state machines by creating and processing a flow chart representation of a telephony service, such as a call waiting service.

### BACKGROUND OF THE INVENTION

This application claims priority U.S. Provisional Application Serial No. 60/377,680, filed on May 3, 2002, and U.S. Provisional Application Serial No. 60/430,720, filed on Dec. 3, 2002, hereby incorporated herein by reference in its entirety.

Delivering voice services over the cable network holds great promise as a service model that will allow cable network operators to expand revenue and services. In particular, the cable network provides a platform that allows for delivering telephone services as part of a “media-rich” suite of services that will provide consumers with a single provider of media services. The economic opportunities are clear and compelling.

However, there are hurdles that must be overcome before cable service network operators can compete with the traditional telephone service companies operating over the public switching telephone network. To begin with, cable television operators need equipment that will support voice/telephone services over the cable network. These telecommunication systems need to be easy to use and integrate into the cable network. However, today cable service network operators are typically faced with telecommunications service solutions and architectures that were developed for other industries, classes of providers, scales, and physical plants. Moreover, cable service network operators must compete against very established telephone companies. To do this, they need to be able to offer services that customers want and cannot get from other providers.

Thus, in today's telecommunication market it is often the case that cable network operators are very interested in customer demand that the service they receive be customized or changed to suit their particular need. Although, customization can be of great value and can reduce customer churn substantially, it is still the case that the development and modification of services can be a time consuming and difficult task. Thus the cost of customizing services can prevent a cable network service provider from fully responding to a customer's needs.

To address this problem, the systems and methods described herein include systems and processes for easily modifying and developing services for a client. By these means the service provider can more easily address concerns and requests of clients, as well as more easily modify services for any purpose, such as for complying with changes in the law or to more efficiently process a call.

### SUMMARY

The systems and methods described herein include, among other things, state machine design tools that generate computer executable state machines from schematic representations, typically flow charts, of a process. In one particular embodiment the processes being represented are processes for implementing a telephony or telecommunication service. For example, the methods described herein include state machine design tools that allow a user to generate state machines by creating and processing a flow chart representation of a telephony service, such as a call waiting service.

As described in more detail below, the systems and methods include a graphical editor that allows for the creation of a schematic representation of a process. In one embodiment the graphical editor is a drawing package, such as the Microsoft Visio drawing package, that may be used in cooperation with a flow chart template to provide an environment in which to describe telecommunication state machines. The drawing package may be employed to draw and save, as well as manipulate or modify, flow chart representations of a telecommunication service. The drawing package allows for the created flow charts to be saved in an intermediate language format that captures the physical description of the graphical representation of the process as well as information representative of the content in that flowchart. In one example, the editor is the Microsoft Visio editor which allows for a created flowchart to be saved an XML format. Thus, the Visio documents representing a state machine may be saved as an XML document.

A parser processes these intermediate language documents to create a state event table that can direct the operation of a state machine engine. In one embodiment, the parser processes the intermediate language file to create an output file that includes an initialized state diagram data structure that stores information representative of the state machine's response to an incoming event. The output file may also include one or more executable functions that may be referenced by the data structure for the purpose of carrying out an action that is associated with a particular machine state. To this end, the parser may include a compiler for compiling high-level language instructions into computer executable code. Additionally, the parser may include an intermediate language parser that processes the intermediate language file to identify and add information employed for compiling the high-level instructions. Information that gets added can include function names generated by the parser and state numbers, as well as any other information the compiler will employ when compiling down the source code. In one embodiment, the parser includes a C-language compiler that can separate C-language instructions that have been embedded into the template objects within the flow chart diagram. Additionally and optionally, the parser may modify the intermediate language so it is in a format that may be more easily translated into the event table.

The systems and methods described herein may further generate a listing file. This listing file, typically in XML, adds useful information to the graphical source file. Such information may be the function names for threads of execution, the actual state numbers automatically generated for weights, states and decision boxes, and a graphical function for highlighting any errors found when compiling the XML, or other intermediate language, source.

The source code files are processed by a state machine engine that uses the data structures and functions defined in the source file to implement a state machine representative of the graphically depicted process.

In another aspect, the invention provides processes for creating a computer executable state machine for carrying out a telecommunication service.

Such processes may comprise providing an editor having a template of objects representative of generic operations capable of occurring during the service and employing the objects to generate a flow chart diagram of a telecommunication service; modifying an object in the diagram to add information content representative of a computer instruction for carrying out an action for the service; translating the graphical description into a set of set of instructions in an intermediate language capable of representing the content and structure of the flow chart diagram; and parsing the intermediate language to generate a state event table having a set of computer executable instructions and a data structure having information representative of the state machine response to an incoming event, whereby the state event table drives operation of a state machine engine.

Other aspects of the systems and methods described herein will be apparent from the following figures and following description of certain illustrative embodiments.

### BRIEF DESCRIPTION OF THE DRAWINGS

The present disclosure may be better understood and its numerous features and advantages made apparent to those skilled in the art by referencing the accompanying drawings.

FIG. 1 depicts a first embodiment of a system according to the invention.

FIG. 2 depicts one example of a flow chart diagram of a telephony service that may be processed as described herein to create a state machine;

FIG. 3 depicts one example of a design template that may be employed with an editor program to create flow chart diagrams capable of being processed as described herein;

FIG. 4 depicts on example of a flow chart diagram of a process;

FIGS. 5A and 5B depicts two embodiments of a decision box object;

FIG. 6 depicts graphically the translation of an object in a flow chart diagram to a set of plural objects representing an intermediate language representation;

FIG. 7 depicts graphically parsing and mapping graphical information into computer instructions; and

FIG. 8 depicts on example of a state event table.

The use of the same reference symbols in different drawings indicates similar or identical items.

### DETAILED DESCRIPTION

To provide an overall understanding of the invention, certain illustrative embodiments will now be described. However, it will be understood by one of ordinary skill in the art that the systems and methods are not limited to a particular embodiment and may be adapted and modified for other applications and to provide other products. Such other additions and modifications will not depart from the scope hereof.

In one embodiment, the system comprises a drawing editor, such as the Visio drawing editor sold by the Microsoft Corporation of Redmond, Wash. The drawing editor may include a design template that provides a set of shapes and connectors that may be employed when creating or modifying a drawing that represents how a telecommunication service is handled. Thus, in this embodiment telecommunication services may be represented by drawings created in the Visio.

The system includes a translator that translates the Visio drawing into a set of commands that can execute on the telecommunication equipment. To this end, the drawing program design template comprises a set of shapes and connectors that are associated with commands and instructions. The translator can process these shapes and connectors to develop a set of instructions, such as a set of XML instructions, that represent the service presented in the drawing. In one embodiment, the systems use the Visio to XML translator that converts the service template into XML instructions that represent the process depicted in the figure. It will be understood to those of ordinary skill in the art that starting with the commercially available Visio 2002 program, Visio is able to save drawings, templates and stencils in “XML for Visio” format, and therefore includes a translator for converting a Visio drawing into a set of XML instructions. Once converted, these XML instructions may be passed to a parser.

The parser, in one practice, is capable of modifying as necessary the XML instruction set and generates as an output file, a state event table into a set of C-Code instructions. The C-Code may be separated into a set of functions that can be accessed and used by the state event table. The state event table may be stored within the computer instruction memory of the telecommunication equipment and employed when servicing a telecommunication request for that subscriber. In this way, the systems and methods described herein provide a simple and facile system for creating and modifying services and features provided to customers.

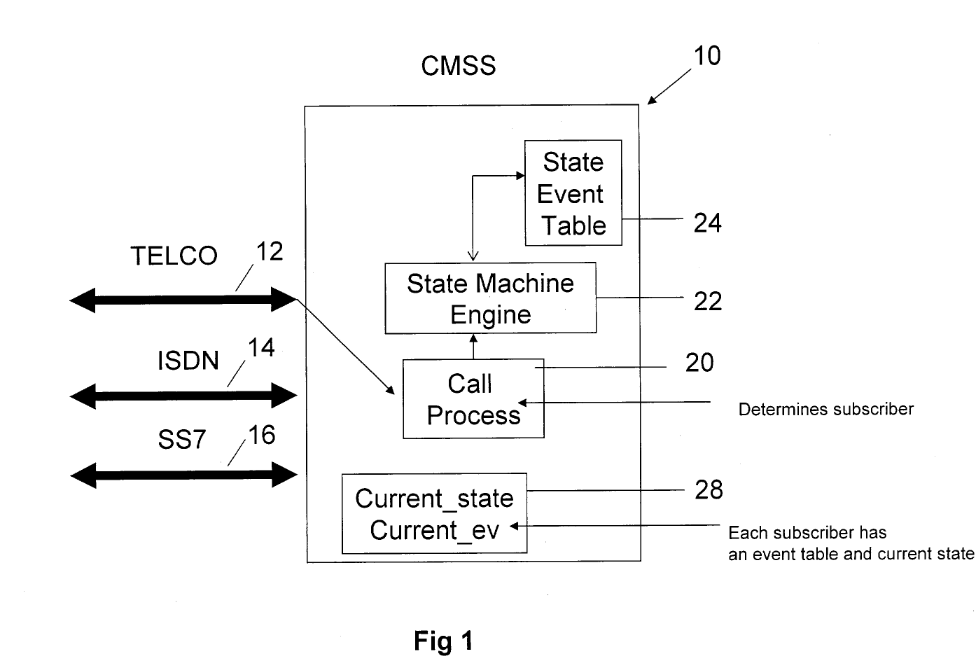

FIG. 1 depicts one system 10 that employs an event table of instructions for servicing a telecommunication event. More particularly, FIG. 1 depicts a call management service system (CMSS) 10 that couples to a TELCO trunk 12, an ISDN trunk 14 and an SS7 signaling channel 16. Within the CMSS 10 there is a call process procedure 20, state machine interpreter 22, and state event table 24.

The state machine engine 22 may be a software process that takes the state event table 24 and the current event data as input and executes the action routine as described in the state event table 24. Additionally, FIG. 1 shows that for a subscriber there is a state table 28 that includes, for each subscriber, an event table and the current state of the subscriber. In one embodiment every subscriber has its own event table and its own current state. Thus, a call coming in, for example across the TELCO trunk 12, may be received and processed by the call process procedure 20. The call process procedure 20 can determine the subscriber that is to be associated with the incoming call. In one practice, the subscriber is determined by reviewing the SS#7 or MF signaling information and identifying the ANI. However, any suitable technique may be employed. For that subscriber, the call process procedure 20 can identify a subscriber state table 28 that indicates the current state of the subscriber, and an event table associated with that subscriber. The state of the subscriber may indicate that the subscriber is currently idle, off-hook, forwarding calls, call-connected, or in some of state. The current event information stored in the table 28 indicates the event received by the call process procedure 20 when servicing the call from the TELCO trunk 12. Accordingly, the call process procedure 20 can process information from the TELCO trunk 12 to determine which subscriber is being contacted, the current state of that subscriber and the current event that is incoming from the trunk 12 as well as a table id that is associated with that subscriber and the trunk protocol in play (such as SS7, ISDN, etc.). Once the call process procedure 20 has determined this information, the interpreter 22 may begin processing instructions relevant to the current event and the current state information for that subscriber. In one embodiment, the state machine engine 22 is a set of machine code executing within the instruction memory of the CMSS 10.

As will be described in more detail below, the state machine engine has the ability to receive an initial designation of the present state of the machine. This state information may be used as an index into the data structure of the state event table. Once the indexing operation has occurred the state machine engine will switch to its next state based on the type of the state. The engine 22 can respond to information from the call process procedure 20 such as the trunk protocol employed and other information necessary for setting up a process for servicing this new event. At one point, the engine 22 executes a “jump on” instruction that directs the execution of the machine code in the engine 22 to the appropriate instruction within the event table 24. In one embodiment the event table is compiled instructions typically in machine code. Typically the event table 24 could be a DLL, or some other kind of file that can store instructions that may be executed by the system 10 described herein. Within the event table 24 is a set of instructions that carrying out the procedure for the event for that respective subscriber.

As will be seen from the below example, the systems and methods described herein make it easy to modify a service or feature. The following is an example case of using the state machine design tool for processing a call to/from subscriber:

A) A Telecomm Trunk generates an event to the call processing process 20, notifying it of the incoming call for a particular subscriber.

B) The CMSS 10 derives the current state event table location (pointer to the current position in the table) of the subscriber from a database.

C) The CMSS 10 feeds the state machine engine 22 the State Event Table 24 with the current pointer and the current Event. The state machine engine 22 executes the actions related to that event in that state.

Now the following will describe an example of how to change the table:

D) Changing the State Event Table may be as follows.

E) A new table is loaded into the CMSS 10 either compiled into the C code or loaded using dynamic DLL or configuration file.

F) When the Subscriber is IDLE (i.e. not making calls), we can simply change the current pointer for the state event table stored in the database to other table's pointer. E.g. change the current pointer which was pointing to, for example state_variant_{—}1_IDLE_STATE to state_variant_{—}2_IDLE_STATE.

Now all the new calls to/from that subscriber will start executing the new table.

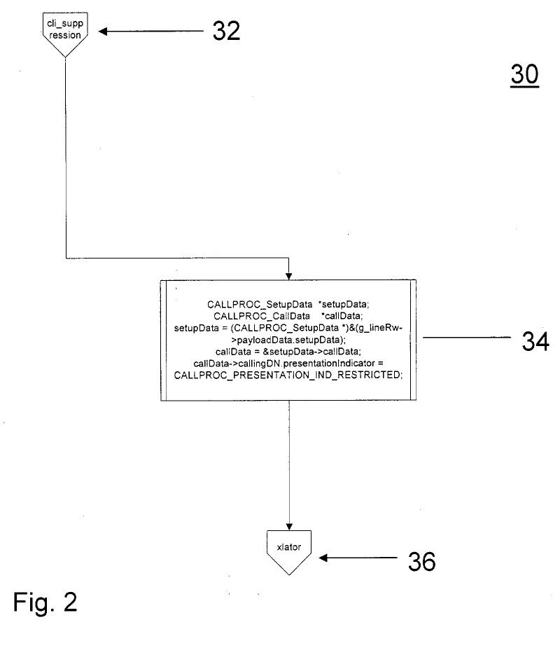

Accordingly, the CMSS 10 of FIG. 1 is, at least in part, an event table driven system that responds to instructions within the state event table 24 for servicing telecommunication events. To this end, and as described above, the creation of event table information may be facilitated by a process that graphically creates a flow chart indicating how a service is to be processed. In one practice, a set of templates for standard services is provided to a programmer intending to modify a service request. One such diagram 30 is presented in FIG. 2. As shown in FIG. 2, the diagram 30 begins at a step 32 that indicates a jump from the state machine engine 22 into the event table 24.

After 32, the procedure jumps to step 34 wherein the call procedure determines the set up data and the call data and begins to set up the call to the subscriber. FIG. 2 illustrates that step 34 includes a plurality of instructions. These example instructions are reprinted within Table 1 below. As can be seen, Table 1 presents a set of instructions that can be used for setting up a call coming into a subscriber. As noted in these instructions, an instruction may be provided for handling caller id information. By modifying the block 34 to include instructions that change the way caller id information is handled a new event table may be created that will include these modified instructions. As described above, the graphical representation 30 may be processed by the Visio program to create a set of XML instructions. These XML instructions may be parsed and turned into C-Code that can compiled down into instruction code which can be stored within the state event table 24. The state event table 24 may be employed by the state machine engine 22 when servicing an event for a particular subscriber, or for any subscriber. It will be understood that optionally, every subscriber may have their own event table or a single event table may be provided for each CMSS system.

TABLE 1

CALLPROC_SetupData *setupData;
CALLPROC_CallData *callData;
setupData = (CALLPROC_SetupData
*)&(g_lineRw->payloadData.setupData);
callData = &setupData->callData;
callData->callingDN.presentationIndicator =
CALLPROC_PRESENTATION_IND_RESTRICTED;

Creating A Graphical Depiction of a Process

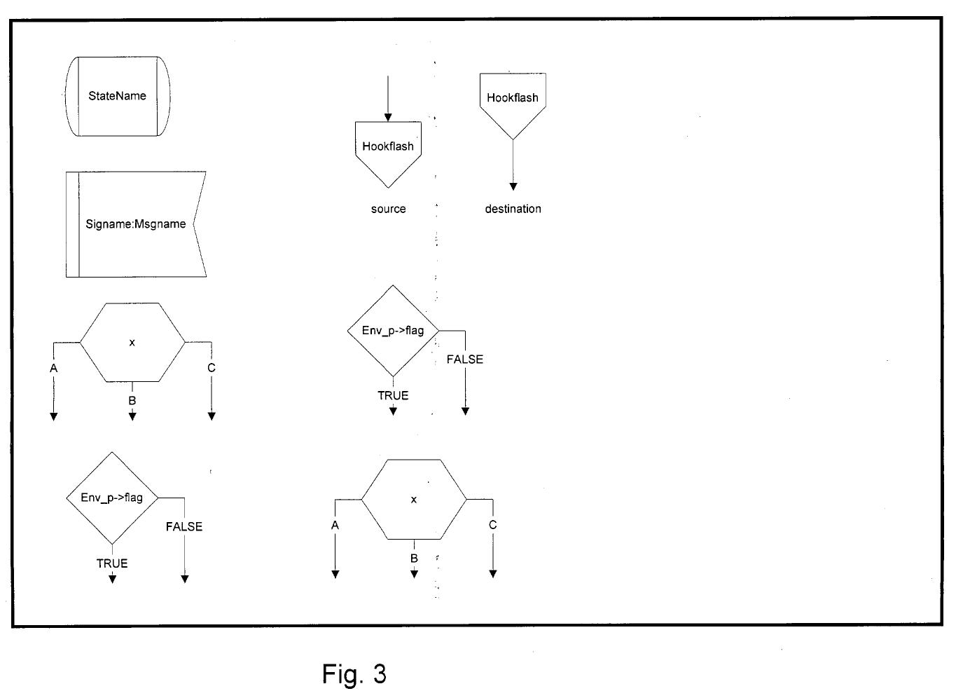

Turning now to FIG. 3. One example of how to create a process flow chart that may be turned into a state machine is depicted. Specifically, FIG. 3 illustrates an SDL machine template that may be imported in an editor, such as Visio, to allow a process designer to use the objects presented in the template to graphically create a representation of a telecommunications service. More particularly, FIG. 3 depicts an SDL machine template 40 that includes a plurality of objects 42-48. The objects include a stable state object 42, a received message object 44, and two types of decision objects 46 and 48. These depicted objects are merely representative of the types of objects that may be part of the template. The actual number of objects and types of objects will vary depending upon the application at hand and any suitable set of objects may be employed by the systems described herein.

The depicted template 40 include objects that describe a set of telecommunication states. In one embodiment these objects include an environment descriptor or object, a stable state object, a received message object, an action object, a message sender object, a decision object box, a weight state object, and a pair of on/off page connectors. Each object may be represented in an intermediate language format, such as XML. As discussed above, Visio allows a user to save a graphical representation of a process, i.e a flowchart, as XML. As also discussed above, XML provides a format that allows for storing content and presentation information, and is thus well suited to this application. However, it will be apparent to those of ordinary skill in the art that the systems and methods described herein are not necessarily limited to any particular intermediate language and any suitable intermediate language including XML, UML, Adobe Postscript, proprietary Visio file format or any other suitable intermediate language., may be used with the systems and methods described herein.

As described above, the pictorial representation of the flow chart may be processed by the systems described herein to create a source code representation of the depicted process. The source code representation may be presented in any suitable high level programming language including C, C++, Java, Fortran, Pascal, or any other suitable language. For the purposes of illustration, the systems and methods described herein will be described with reference to the high level programming language C.

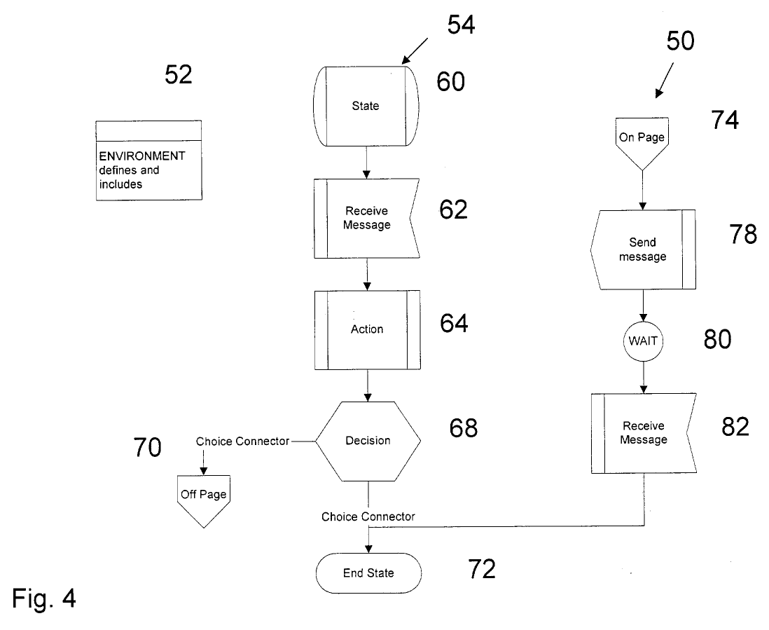

FIG. 4 depicts a prototypical flowchart process for a telecommunication service. The depicted service comprises the various objects available in the SDL machine template arranged in a format that describes a telecommunication service. As illustrated in FIG. 4 the telecommunication service 50 comprises an environment declaration block 52 and a multi-threaded process 54.

The environment declaration block 52 declares different environmental variables and includes a series of “# include” statements that may be user defined. Additionally, global variables in this state machine may be defined in the environment descriptor block. Typically there is one environment descriptor block per state machine and multiple environment descriptors will generate an error.

The depicted process 54 includes two threads. A first thread begins with the depiction of an object 60. The depicted object 60 is a stable state. Stable states may act as root structures for the directed graph that make up the process flow chart. The text within the staple state object may be the state name. Typically this is a constant defined using a # defined in a header file. By convention, state 0 is left unused and the states are numerated starting at 1. The process 54 depicted in FIG. 4 follows the convention wherein the stable state element 60 is provided as the root state for the process 54.

After stable state object 60 the process 54 proceeds to the received message object 62. The received object message 62 indicates that an event has occurred wherein that event is the receipt of a message by the process 54. A received message typically relates to call processing. For example, in SS#7, the first message initiating a new call is IAM. In ISDN, the first message initiating a call is SETUP. The received message state 62 includes a text field that the user can edit to enter a message name. For example, the object 62 may be edited to enter the text field “received call” to indicate that the system has received an indication that an incoming call has been sent to the system. The process 54 proceeds to object 64, which is an action object.

The action object 64 includes a text field that the user can edit to enter a set of high level programming instructions representative of an action that the telecommunication service is supposed to undertake in response to receiving the message identified in object 62. In one embodiment, the text field is edited to include a set of C-code instructions for programming the state machine response. In other embodiments, different forms of high-level representations may be used, including different programming langauges, such as Java, Pascal, or BASIC, or text strings representative of macros. Moreover, in other embodiments the system may provide a series of different action blocks, each of which directs the state machine to perform a certain action. Thus, the user can select among the available action objects to select the desired response. In any case, it will be understood that the action object can be modified by the user to include information that can processed to create one or more executable instruction codes that the state machine can execute.

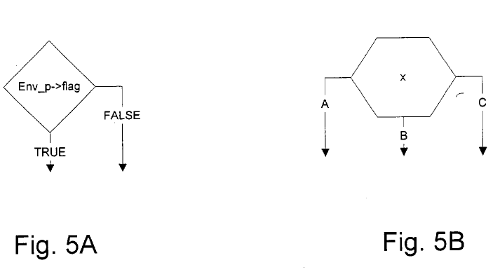

After action object 64, the process 54 proceeds to the decision block 68. In one embodiment, there are two shapes that may be used to represent decision boxes. FIGS. 5A and 5B depict two examples of decision box objects. The text in a decision box object 68 may be any high-level regular programming expression. As described in more detail below, when a thread of execution is generated, this regular expression will be placed as the argument to a function return( ). The outputs of decision box objects are called choice connectors. These are labeled with a string or a numeric constant. The string or constant has the same rules as a Message_Name and may be placed in the same data structure of the state event table 24. Optionally, a decision box object 68 may have an arbitrarily large number of choice connectors as outputs. The tool developer may specify a maximum number of choice connectors as long as it can be increased later if needed.

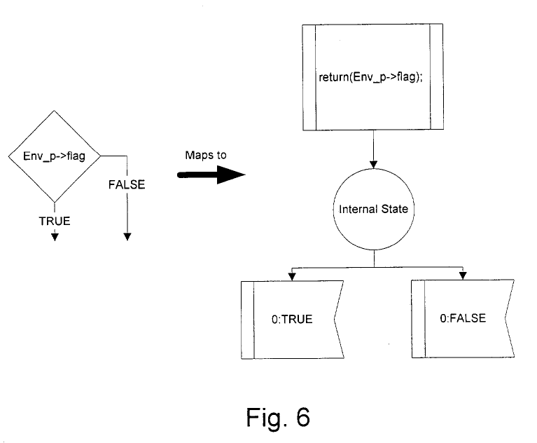

Internally, the translator may optionally represent the decision box object 68 as an action followed by an internally generated internal state. As shown in FIG. 6, the decision box object 68 may be mapped to an alternate representation. As shown, the translator process maps the decision box 68 to an action object 90, an internally generated state object 92 and two received message objects 104 and 108. The translator generates internal state numbers for a decision box object. The internal state number may be placed on a list, such as an XML list file, near the decision box object to aid in debugging. It will be understood that the intermediate language representation may be translated from it intermediate form into a graphical depiction. As such, the modification to the intermediate language, such as the creation of an XML file list that includes internally generated state numbers, can be processed to create a new graphical depiction of the process. This new depiction can portray graphically the additional states and the other modifications made to the representation of the process flow. Thus, the decision box object 68 shown in FIG. 4 may be replaced by the internal representation depicted in FIG. 6.

After the decision box object 68, the process proceeds to either the off page connector object 70, or to the end state object 70. An off page connector (source) object may be attached to the output side of either connector arrows or choice connectors. The output the connecting arrow of an off-page connector (destination) may be attached to an action, a message sender, a stable state, a wait state, or a decision box. The same object used for off page connectors is also used for on-page (the same page within a document) connectors. In a preferred practice, the relationship between source and destination connectors is one-to-one. Multiple source connectors are not allowed to point to one destination connector. To signal the translator of the relationship between a off page (source) object and an on page (destination) object, the text in the source and destination connector are to be identical and unique for that process. Through this practice, Off-page connectors may connect between multiple documents, such as XML documents, for a state machine. Optionally, the translator may have a defined syntax for the text when a connector spans documents. For example, the a syntax such as filename/string. Additionally and optionally, the translator may represent the two portions of a thread of execution joined by an off-page connector as two separate threads of execution

An on-page connector 74 is depicted as the entry point for a thread 50. The on-page connector 74 proceeds into the send message object 78. Message Sender objects behave exactly like Action objects, as described above, and provide blocks of code that are used to send messages. The contents of a Received Message object in the editor, such as Visio, is a symbolic string that a “C” compiler turns into an integer number. For example, the symbolic string “SETUP” might be turned into a 5. A Send object contains executable “C” source code. Typically, the source code is a function call that sends a message. The receive object causes the service to wait and receive message.

Translating The Graphical Description into an Intermediate Language

As discussed above the system can include a translator tool that processes the intermediate language representation to generate a state event table 24. The state event table 24 includes information for driving the operation of the state machine engine 22.

To this end, the translator tool, in one embodiment, accesses the set of intermediate language documents, such as XML files, and produces and output file, such as a C language file. The translator tool typically is a software process executing on a data processing platform. The software tool that takes the XML schema or, in some alternate embodiments, command line interface (CLI) text commands, as input and produces software instructions in a high level language (C, in one embodiment) suitable for cross-compiling into application software object code that can be downloaded and used on a target control system, such as a telephony switch system.

In one embodiment, the translator includes an environment attribute process that searches through the XML documents to find the environment information provided in the environment descriptor object 52. With this information the translator tool produces an output ‘C’ file that has a preamble of user-defined code that is usually #include statements and global variable definitions. Global variables are defined in ‘C’ and positioned in the output file before the rest of the automatically generated code. Typically, the global variables are set appropriately before entering into the design tool and retrieved once the processing is done.

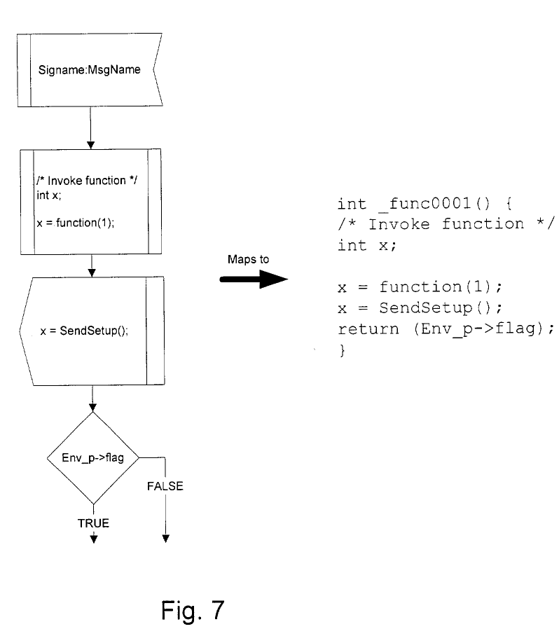

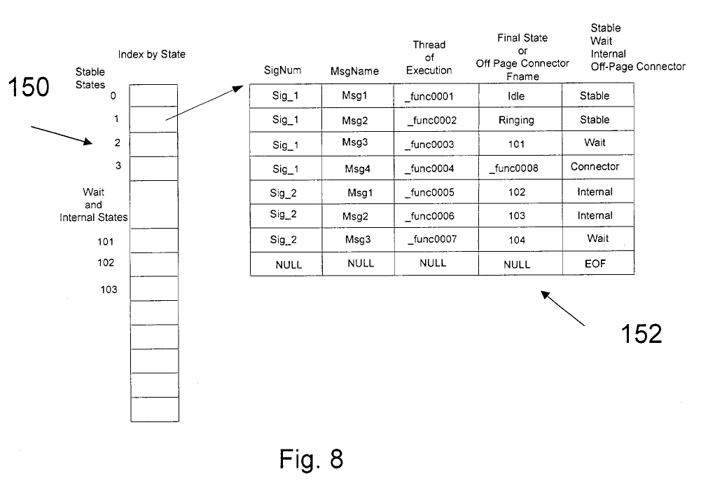

The translator tool further comprises a compiler process that identifies the C language functions in the XML documents. FIG. 7 depicts the process wherein the tool identifies programming instructions within the XML and generates a set of instructions that can be compiled down to carry out the functions that will are required by the depicted thread. These functions are each compiled down to computer executable instructions. It produces a set of functions for each thread of execution. The functions are organized into the output file and placed in a location set aside for executable code. After these functions, the translator tool generates a set of statically initialized data structures. To this end the tool includes a structure initializer for storing data within data structures associated with the state event table. One such set of data structures is depicted in FIG. 8. As shown therein, there is a root data structure 150 that is indexed by state. It points to a data structure 152 that is searched by message. That data structure 152 then provides the address of a thread of execution function to invoke and a final state to go to after the thread is executed. Thus, the state event table includes a root data structure 150 that includes a reference to each state in the telephony process, including user defined states and internally generated states. For each state there is a pointer to a portion of the data structure 152. In the data structure there are a series of entries, on entry for each message that can be handled by that state. Associated with each message is a function that indicates the action to perform, as well as the state to which the state machine should enter once the action is completed. Thus, it can be seen that the system provide a state machine generator that is capable of processing a high level programming language instructions to create a state event table, like the one depicted in FIG. 8, for driving the operation of a state machine engine 22.

Optionally, the translator tool generates a listing file. This file will also be in XML and will add useful information to the graphical source file such as function names for threads of execution, the actual state numbers automatically generated for wait states and decision boxes, and a graphical way to highlight any errors found in compiling the XML source. As such, the translator can include a list generator process that may be a software process capable of parsing XML and editing the XML to modify its structure and content so that additional information, such as internally generated states, are added to the document content.

State Machine Engine

With the state event table completed, the system can now use that state event table to implement a state machine that carries out the telephony process of interest.

The state machine engine 22 as depicted in FIG. 1, uses the state event table to carry out the process. The engine 22 has the ability to receive an initial designation of the present state of the process. This state information may be used as an index into the data structure 150 of the state event table 24. As shown in FIG. 8, for each state, there is a list of events and an 1 “end of list” marker. The state machine interpreter does a linear search of the event list looking for a match. Consequently, in this embodiment it is more of a search than and “indexing” operation. However, in other embodiments, searching or another technique may be employed. Once the searching or indexing operation has occurred the state machine engine 22 switches to its next state based on the type of the state. The engine 22 can respond to information from the call process procedure 20 such as the trunk protocol employed and other information necessary for setting up a process for servicing this new event. At one point, the engine 22 executes a “jump on” instruction that directs the execution of the machine code in the engine 22 to the appropriate instruction within the event table 24. In one embodiment the event table is compiled instructions typically in machine code. Typically the event table 24 could be a DLL, or some other kind of file that can store instructions that may be executed by the system 10 described herein.

Table 1 depicts a psuedo-code representation of a portion of one state machine engine 22.

TABLE 1
// Save initial state for <previous state> case

TOP:
// Index on State
// Search table using SigNum : MsgName as key
// If EOF, ***ERROR*** PURGE
NEXT:
// Call function to invoke thread of execution and capture return code
// Select based on final state type

// Case Stable

// if state in table == <previous state> keyword

// set state to initial state

// else

// Set state to state in table

// return

// Case Wait

// Start Wait State Timer and set data structure flag

indicating wait state

// Set state to state in table
// return

// Case Internal

// Set state to state in table
// Set SigNum to Zero, Set MsgName to return code from

thread of execution

// Goto TOP

// Case Off-Page Connector

// Set function to call from table

// Goto NEXT

As can be seen from this pseudo code, the state machine engine 22 employs the contents of the state event table 24 as well as the message information, to the system from one state to the next. As such, the system, which may be for example a telephony switch, a video on demand system, a gaming system or other application becomes a state table driven system. Therefore, upgrading the system is achieved by changing the contents of the state event table 24. This make upgrading a process or service quick and efficient as changes may be made at the state event table 24 and the underlying telephony system does not need to changed or altered.

The system and methods described above can be realized as hardware and software components. The software can be implemented as a C language computer program, or a computer program written in any high level language including C++, Fortran, Java or Basic. The techniques for the development of such programs are known to those of skill in the art, and set forth in, for example, Stephen G. Kochan, Programming in C, Hayden Publishing (1983).

Those skilled in the art will know or be able to ascertain using no more than routine experimentation, many equivalents to the embodiments and practices described herein. Moreover, the systems and methods described herein may be employed in many applications besides telephony services, including gaming, video-conferencing, billing, and other applications. Accordingly, it will be understood that the invention is not to be limited to the embodiments disclosed herein, but is to be understood to be interpreted as broadly as allowed under the law.

1. A state machine design system for generating a computer executable state machine, comprising
an editor for generating a graphical description of a process,
a translator for translating the graphical description into a set of set of instructions in intermediate language,
a parser capable of parsing the intermediate language into a set of high level programming language instructions, and
a state machine generator capable of processing the high level programming language to create a state event table for driving the operation of a state machine.

2. A system according to claim 1, wherein the state event table includes a set of computer executable functions and an initialized data structure storing information representative of a state machines response to an incoming event.

3. A system according to claim 2, wherein the state event table includes a root data structure indexed by state and storing pointers into the initialized data structure.

4. A system according to claim 1, wherein the state event table includes an environment descriptor representative of information for allowing the computer executable functions to execute

5. A system according to claim 1, further comprising
a state machine template having a plurality of objects for graphically depicting a process.

6. A system according to claim 5, wherein the objects include a text field for receiving user-generated input.

7. A system according to claim 5, wherein the translator includes means for processing the user-generated input to determine the action of the object with the process.

8. A system according to claim 5, wherein the template includes a connector object for logically connecting multiple graphical descriptions into a unitary graphical representation of the process.

9. A system according to claim 8, wherein the translator includes means for identifying connector objects to process and combine a multi-page graphical description of a process.

10. A system according to claim 5, wherein the objects include a stable state object for defining a root state for a directed graph within the graphical representation of the process.

11. A system according to claim 5, wherein the objects include a received message state capable of storing a message string representative of an event.

12. A system according to claim 11, wherein the parser includes a structure initializer for placing the message string within a data structure associated with the state event table.

13. A system according to claim 5, wherein the objects include an action object capable of storing a set of high-level programming language instructions.

14. A system according to claim 13, wherein the parser includes a compiler for compiling the high-level programming language instructions into computer executable instructions and for placing the computer executable instructions into the state event table.

15. A system according to claim 5, wherein the objects include a message sender object capable of storing a set of high-level programming language instructions.

16. A system according to claim 15, wherein the parser includes a compiler for compiling the high-level programming language instructions into computer executable instructions for sending messages and for placing the computer executable instructions into the state event table.

17. A system according to claim 5, wherein the objects include a decision object capable of storing a set of high-level programming language instructions representative of instructions for selecting between at least two outcomes.

18. A system according to claim 17, wherein the decision object includes two or more choice connection outputs each having an associated identifier label.

19. A system according to claim 17, wherein the parser includes a compiler for compiling the high-level programming language instructions into computer executable instructions for returning a selected expression and a structure initializer for placing the computer executable instructions into the state event table.

20. A system according to claim 17, wherein the translator includes a process for representing a decision object as a set of objects including an action, an internal state and at least two outputs.

21. A system according to claim 5, wherein the objects include a wait object representative of an instruction to wait for a predetermined response.

22. A system according to claim 21, further including a state machine engine capable of setting a wait state timer to be associated with a wait state object.

23. A system according to claim 1, wherein the state machine engine includes a switch for switching between states as a function to type of state.

24. A system according to claim 23, wherein type of state includes a type selected from the group consisting of stable state, wait state, internal state and connector state.

25. A system according to claim 1, further comprising a list generator for processing the set of instructions in intermediate language to generate a file of listing information representative of information for labeling the graphical description of the process.

26. A system according to claim 1, wherein the intermediate langauge comprises XML.

27. A system according to claim 1, wherein the editor comprises an application program capable of allowing a user to draw process flow diagrams and store process flow diagrams as XML files.

28. A process for creating a computer executable state machine for carrying out a telecommunication service, comprising
providing an editor having a template of objects representative of generic operations capable of occurring during the service and employing the objects to generate a flow chart diagram of a telecommunication service,
modifying an object in the diagram to add information content representative of a computer instruction for carrying out an action for the service,
translating the graphical description into a set of set of instructions in an intermediate language capable of representing the content and structure of the flow chart diagram,
parsing the intermediate language to generate a state event table having a set of computer executable instructions and a data structure having information representative of the state machine response to an incoming event, whereby the state event table drives operation of a state machine engine.
